(19) United States
(12) Patent Application Publication
(10) Pub. No.: US 2012/0265872 A1
(43) Pub. Date: Oct. 18, 2012

(54) Systems and Methods of Automatically Remediating Fault Conditions

(75) Inventor: James Chilton, Roswell, GA (US)

(73) Assignee: COX COMMUNICATIONS, INC., Atlanta, GA (US)

(21) Appl. No.: 13/089,262

(22) Filed: Apr. 18, 2011

(51) Int. Cl. G06F 11/30; G06F 15/173

(52) U.S. Cl. 709/224

(57) ABSTRACT

Example embodiments of the systems and methods of automatically remediating fault conditions disclosed herein retrieve information from the hardware, apply algorithms around that reading, and identify solutions that can correct the condition automatically. These systems and methods reduce the need for human intervention and provide a self-correcting procedure to the hardware itself.

### TECHNICAL FIELD

The present disclosure is generally related to electronic systems and, more particularly, is related to remediating fault conditions in electronic systems.

### BACKGROUND

Network fault management can be a sizable challenge due to downsizing in team size. The task becomes more complicated if the fault management is for a remote site or remote equipment and a technician is dispatched to the site only to find out the problem is something that could have been fixed remotely; or the appropriate equipment is not available on the service vehicle and the technician needs to spend additional time to retrieve it, extending service restoration time.

In many cases, the time taken to identify the root cause of a problem is actually longer than the time taken to fix it. Many network devices are capable of sending out Simple Network Management Protocol (SNMP) traps when a fault occurs. A good network fault monitoring system should be able to support SNMP traps and provide meaningful information to an operator. But the monitoring systems often stop there. Then it is up to an operator to examine the monitoring information, determine a remediation approach and fix the fault. There are heretofore unaddressed needs with these previous solutions.

### SUMMARY

Example embodiments of the present disclosure provide systems of automatically remediating fault conditions. Briefly described, in architecture, one example embodiment of the system, among others, can be implemented as follows: memory configured for storing equipment conditions; and at least one application server configured to: query the memory; determine a status level for equipment, the status level corresponding to the system conditions; and automatically perform a remediation routine if the status level is critical.

Embodiments of the present disclosure can also be viewed as providing methods for automatically remediating fault conditions. In this regard, one embodiment of such a method, among others, can be broadly summarized by the following steps: monitoring at least one system condition; determining a status level for the system based on the condition; and automatically performing a remediation routine without user interaction if the status level is critical.

### BRIEF DESCRIPTION OF THE DRAWINGS

FIG. 1 is a block diagram of an example embodiment of a system for automatically remediating fault conditions.

FIG. 2 is a block diagram of an example embodiment of a system hardware device of the system of FIG. 1.

FIG. 3 is a diagram of an example embodiment of a remediation system of the system of FIG. 1.

FIG. 4 is a flow diagram of an example embodiment of a method of automatically remediating fault conditions.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

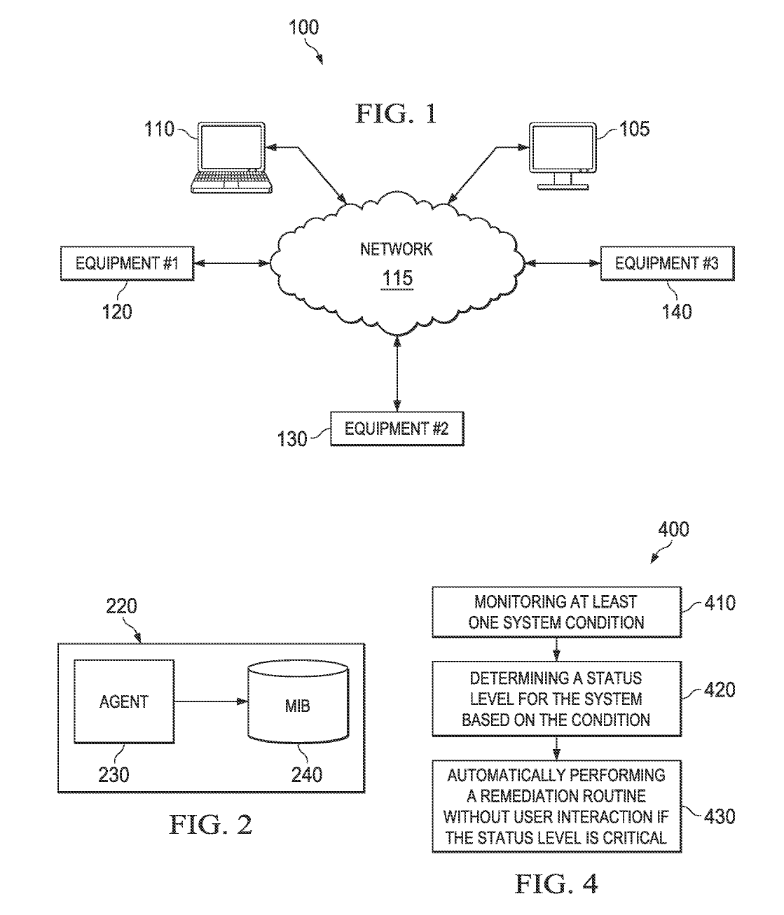

Systems and methods of automatically remediating fault conditions disclosed herein may provide a product/service which would identify triggers/alarms/issues within a network and self-correct the problem without human intervention. FIG. 1 provides a typical network which may be monitored and automatically remediated when a fault condition occurs. Equipment #1 120, equipment #2 130, and equipment #3 140 may be connected to network 115. Many different types of equipment devices may be monitored for fault conditions. The devices may include, as non-limiting examples, set-top boxes, network devices, power equipment, computer hardware and software, and various pieces of electronic hardware. A user may monitor the operation or status of equipment 120, 130, 140 with monitoring device 105. When the disclosed systems and methods remediate a fault condition, an alert may be sent to system 110 for notification purposes. In previous networks, this equipment is monitored to ensure that employees can react to triggers, alarms, and outages.

These triggers and alarms can be presented to operators by way of a hardware Management Information Base (MIB) via agents residing on the hardware. These MIBs may be managed by Simple Network Management Protocol (SNMP). The format of the MIB may be defined as part of the SNMP. SNMP may be used to manage elements within attached networks and the Internet. Through the use of SNMP commands such as “GET” or “GET-NEXT”, for example, information may be obtained using custom-defined MIB to provide valuable information about a piece of hardware, for example, to provide the state the hardware is in (i.e. failure, operational, etc.).

The disclosed systems are proactive, automatic remediation systems. There is a server that stores the application code. In example embodiments, the hardware has an MIB database, and information such as fan speed is stored in the MIB. A SNMP command may be used to access the information in the MIB. So if a fault occurs in a piece of equipment that is connected within the network, the fault may be remediated automatically without human interaction. In an example embodiment, the hardware may contain components such as a processor, a CPU, memory, a power supply, and a fan, among others. A centralized system proactively watches the device and, if something goes awry, the disclosed systems and methods can automatically fix the problem based on remediation routines that have been built for that device. These systems and methods may be applied to any device in the system that is addressable. The disclosed systems and methods could cross different services such as video, high speed data, telephone, etc.

A simple high level view of an MIB and its components is depicted in system hardware device diagram 220 in FIG. 2. A user will make an SNMP request for information for device 220. Agent 230 in hardware 220 receives and processes those SNMP queries and events. Those events that are stored in MIB 240 are presented back to the user. In an example embodiment, MIB 240 may include the following information on a piece of hardware or software: Object Name, Syntax, Access, Status, Description, and Other Information. The operator or user may use agent 230 to query MIB 240 to get temperature data, for example, for a particular piece of equipment attached to a network that is being monitored. The request may be made via hardware agent 230 and then extracted from MIB 240 containing the temperature reading associated to the MIB identifier and then data for that event is released back to the user. The results from the query in an example embodiment may be: Temp/Equip#1_temp_reading/Read-Only/212/Temp Reading Equip#1/Chassis Fahrenheit. In this case, the temperature of Equipment #1 is 212 degrees Fahrenheit.

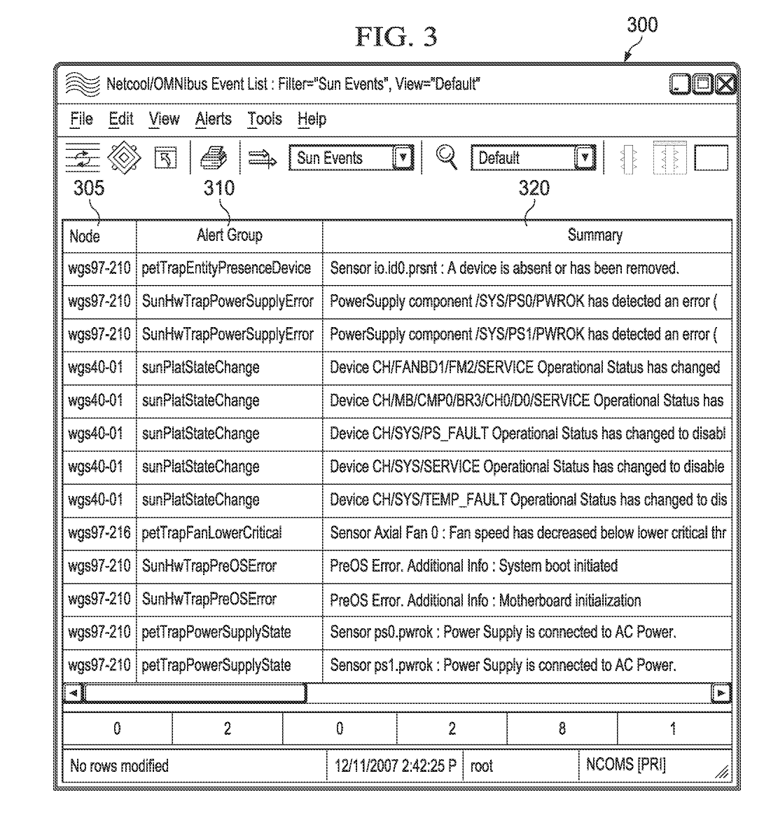

For example, a reading of 212 F may signal a critical condition and be translated as an overheating problem. This condition may be displayed in a user application as Orange—Warning. In an example application, clicking on the Orange label would then provide details to the user such as temperature and the specific hardware that is sending back the critical temperature reading. This information may also be transmitted automatically to a user station and delivered with a database system and monitoring system such as system interface 300 of FIG. 3.

An example embodiment of a monitoring and reporting system is provided in FIG. 3. In the example embodiment, an operator can monitor the functionality of the network, monitor the functionality of hardware components, and distinguish between normal operating behavior and underperforming behavior. In previous solutions, when an operator is prompted on his screen concerning an issue that requires resolution, (for example, a RED condition), he will either try to resolve the problem himself or escalate the problem to a higher level remediation group. This may require ticket entries, phone calls, emails, and paging devices, among other procedures and devices to identify an appropriate person to correct the problem. In the disclosed systems and methods, the problem may be resolved without human interaction.

FIG. 3 provides an example embodiment of system 300 for monitoring an event list. An entry in the event list may comprise a node, a responsible group or agent, a fault condition, and a status level among other information. Node list 305 provides a list of nodes that are being monitored. Alert Group list 310 provides the group that is alerted when a node in node list 305 is in a fault condition. Summary list 320 provides a description of the fault that has occurred with the node of node list 305. In an example, a power supply has been detected as having an error. Typically a human would be watching the screen for a critical fault notification and the fault would be assigned to remediation personnel to fix the fault. However, in the disclosed systems and methods, the system will detect the error and determine whether it can be remediated by automatic steps before a human has to take action on it. For example, there may be some back up hardware or hardware redundancy to which some or all of the processes may be offloaded while the faulty hardware is taken offline and/or replaced. Another typical remediation action may be to slow down the processing until the temperature comes down to an acceptable range.

An example embodiment of the systems and methods of automatically remediating fault conditions implements a proactive and automated approach to resolving issues. Those that do not need immediate attention but can interfere with the stability of the hardware, software, and other functions are well suited to these systems and methods, although critical functions, devices, and processes may benefit as well.

Example embodiments of the systems and methods of automatically remediating fault conditions disclosed herein retrieve information from the hardware, apply algorithms around that reading, and identify solutions that can correct the condition automatically. These systems and methods reduce the need for human intervention and provide a self-correcting procedure to the hardware itself.

If the temperature reading example is used, the disclosed systems and methods retrieve information from the hardware, apply algorithms to that information, and identify solutions that can correct the condition automatically. For the following entry in MIB 240, Object Name/Syntax/Access/Status/Description/Other, the data may be, for example:

Temp/Equip#1_temp_reading/Read-Only/212/Temp Reading Equip#1/Chassis Fahrenheit

Prior to implementation, a remediation algorithm may be implemented to include corrective action to be taken. An example remediation routine may include:

If temp reading>210, set Equip#1_fan_speed to 90%.

If temp reading=210, set Equip#1_fan_speed to 60%

If temp reading<210, set Equip#1_fan_speed to 40%.

In another example implementation, Video-On-Demand (VOD) streaming hardware provides On-Demand service to cable customers. If example embodiments of the systems and methods of automatically remediating fault conditions are enabled, fault conditions in the VOD hardware may be addressed. For example, a software process on the VOD hardware has stopped working. This software process can impact the ability to provide VOD services to customers if it is not resolved quickly. With previous solutions, a customer calls into a customer care call center concerning video issues with his VOD service. An agent in the customer care call center contacts the local VOD administrator to notify her regarding the customer VOD issue. The local VOD administrator then creates a ticket with the hardware vendor. The local administrator notifies local and corporate engineering about the issue. The hardware vendor calls local engineering to investigate the problem. After several hours of research, it is found that the best thing to do in this situation is to restart the software process that stopped working.

Using example embodiments of the systems and methods of automatically remediating fault conditions disclosed herein, a remediation routine is run, and an alert is sent over to a central network operations center to notify the operations analyst of what is occurring and providing the solution to the problem. Continuous updates may be presented to the operations analyst throughout the self-correcting sequence. In other words, the example embodiments identify the stopped software process and through its database and information retrieved from the MIB, and identify that the appropriate remedy to the solution is to restart the software process on the device. The example embodiments then proceed with restarting the software process. As this is going on, a message may be sent to a central operations analyst providing her with details and a status of what just occurred. Additionally, the analyst will be apprised of whether the self-correcting sequence resolved the problem. Thus, an attempt to resolve the fault is performed before a customer support call is made.

There may be many levels for self-correction. For instance, if restarting the software process does not work, the next corrective action that the example embodiments may take may include a reboot of the machine itself, for example. Finally, if all levels of self-corrective solutions are exhausted, then a higher level of alert may be sent (for example, changing the alert status from orange to red) and corrective human resources may be engaged to remedy the situation. In addition, the example embodiments may provide a detailed log of what has transpired and, thus, eliminate initial solutions which save human time in diagnosing the problem.

The systems disclosed herein may monitor several different devices simultaneously. For instance, if there is a graphics card in a computer and if an additional load is applied to the graphics card, the graphics card may start to heat up. There may be instructions within the graphics code which would increase the fan speed to cool the card down if, for example, the temperature of the graphics card is 150 degrees, to avoid a potential shutdown situation. That event may be expanded across much more robust platforms (for example, video on demand), which may consist of hundreds of cases of equipment in a given area. The same concept may apply to software as well as to hardware. The disclosed systems and methods automatically recognize a condition that impacts the service and accesses rules that are applied to automatically fix this condition. Additionally, a message may be sent to an engineer to alert her that a particular action was taken to circumvent the problem. This technique may be expanded across any kind of service, any kind of platform, any kind of hardware or software device.

In another example implementation, a hard drive starts to act strangely, starting to fail. The automated system monitors the hard drive in real time and if the hard drive begins to exhibit fault conditions, then the disclosed system may, for example, take the hard drive offline and run diagnostics or a de-fragment routine to verify the integrity of the hard drive. The routine is all automated with no human interaction, except that the engineer or operator may receive reports on what equipment or service is becoming marginal and what routine was used to remediate the problem. Based on the reported conditions, the recommended action may be to halt the process and restart it to resolve the problem. If this remediation routine is not successful, then a further remediation routine may be to stop the process altogether, or to reboot the entire device. If the hard drive is deemed to be unrepairable by the system, then the system may report to the engineer that the hard drive may need to be replaced.

FIG. 4 provides flow diagram 400 of a method of automatically remediating fault conditions. In block 410, at least one system condition is monitored. In block 420, a status level for the system is determined based on the condition. In block 430, a remediation routine is automatically performed without user interaction if the status level is critical.

The flow chart of FIG. 4 shows the architecture, functionality, and operation of a possible implementation of loyalty currency payment software. In this regard, each block may represent a module, segment, or portion of code, which comprises one or more executable instructions for implementing the specified logical function(s). It should also be noted that in some alternative implementations, the functions noted in the blocks may occur out of the order noted in FIG. 4. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non exhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A method comprising:
monitoring at least one system condition;
determining a status level for the system based on the condition; and
automatically performing a remediation routine without user interaction if the status level is critical.

2. The method of claim 1, further comprising determining if the status level is remediated to a non-critical status level.

3. The method of claim 1, further comprising storing the at least one system condition in a management information base (MIB).

4. The method of claim 3, wherein the monitoring comprises querying the MIB.

5. The method of claim 1, wherein monitoring the at least one system condition comprises using a simple network management protocol (SNMP).

6. The method of claim 1, further comprising identifying a remediation routine based on the state of the system condition.

7. The method of claim 1, further comprising sending an alert comprising the system, the system condition, the status level before the remediation routine, the remediation routine performed, and the status level after the remediation routine.

8. A response system comprising:
memory configured for storing equipment conditions; and
at least one application server configured to:
query the memory;
determine a status level for equipment, the status level corresponding to the system conditions; and
automatically perform a remediation routine if the status level is critical.

9. The response system of claim 8, wherein the memory comprises at least one of hard disk memory, flash memory, random access memory, and non-volatile memory.

10. The response system of claim 8, wherein the equipment conditions are stored in a management information base (MIB) in the memory.

11. The response system of claim 8, wherein the at least one application server is further configured to determine if the status level is remediated to a non-critical condition.

12. The method of claim 8, wherein the at least one application server is further configured to identify a remediation routine based on the state of the system condition.

13. The method of claim 8, wherein the at least one application server is further configured to send an alert comprising the system, the system condition, the status level before the remediation routine, the remediation routine performed, and the status level after the remediation routine.

14. A computer readable medium comprising a computer program, the computer program comprising instructions for:
at least one system condition;
determining a status level for the system based on the condition; and
automatically performing a remediation routine without user interaction if the status level is critical.

15. The computer readable medium of claim 14, further comprising instructions for determining if the status level is remediated to a non-critical status level.

16. The computer readable medium of claim 14, further comprising instructions for storing the at least one system condition in a management information base (MIB).

17. The computer readable medium of claim 16, wherein the instructions for monitoring comprises instructions for querying the MIB.

18. The computer readable medium of claim 14, wherein the instructions for monitoring the at least one system condition comprises instructions that use a simple network management protocol (SNMP).

19. The computer readable medium of claim 14, further comprising instructions for identifying a remediation routine based on the state of the system condition.

20. The computer readable medium of claim 14, further comprising instructions for sending an alert comprising the system, the system condition, the status level before the remediation routine, the remediation routine performed, and the status level after the remediation routine.
